(19) United States
(12) Patent Application Publication
(10) Pub. No.: US 2008/0180318 A1
(43) Pub. Date: Jul. 31, 2008

(54) Method and Apparatus for Reconstructing Time of Transmit from Assisted or Weak Signal GPS Type Observations

(76) Inventors: Eamonn P. GLENNON, Torrens (AU); Roderick Bryant, Conder (AU); Ian Anthony Sainsbery, Narrabundah (AU); John Kenmure Gordon, Hawker (AU)

Correspondence Address: GOTTLIEB RACKMAN & REISMAN PC, 270 MADISON AVENUE, 8TH FLOOR, NEW YORK, NY, 10016-0601, US

(21) Appl. No.: 11/769,259

(22) Filed: Jun. 27, 2007

Related U.S. Application Data
(63) Continuation-in-part of application No. 11/460,784, filed on Jul. 28, 2006.
(60) Provisional application No. 60/703,637, filed on Jul. 29, 2005.
(60) Provisional application No. 60/703,638, filed on Jul. 29, 2005.

(51) Int. Cl. G01S 5/00

(52) U.S. Cl. 342/357.06

(57) ABSTRACT

The invention provides a GPS device that resolves timing errors as applicable to an AGPS navigation solution. A single state algorithm provides rapid convergence, typical with standard Newton-Raphson performance. Problems due to ill-conditioning of the input matrix are identified by an augmented DOP calculation procedure, which may be used to identify unreliable results or to estimate the errors for those results.

This patent is a continuation in part of Ser. No. 11/460,784, filed Jul. 28, 2006, which claims the priority of U.S. provisional patent application 60/703,637 filed Jul. 29, 2005 entitled “Solution of Timing Errors for AGPS” and priority of U.S. provisional patent application 60/703,638 filed Jul. 29, 2005 entitled “Novel Cross Correlation Mitigation Technique.”.

### FIELD OF THE INVENTION

This invention relates to Global Navigation Satellite Systems (GNSS), including pseudolite systems, GNSS positioning and timing with limited assistance such as indoors or in a heavily obscured location where the time of transmit of satellite signals is not available from the navigation message data. In particular it concerns the reconstruction of time-of-transmit from the course acquisition code of weak signals or where assisted-GNSS is employed.

### BACKGROUND OF THE INVENTION

Assisted GPS (AGPS) navigation solutions differ from normal GPS navigation solutions due to the use of ambiguous code-phases rather than full time-of-transmits for each GPS satellite observation. As such, it is necessary to reconstruct the full time-of-transmit using a-priori knowledge such as a position estimate within 75 km of the true position and an estimate of the time-of-receipt. Errors arise if the initial time-of-receipt used to construct the time-of-transmit observations is in error.

The Enhanced-E911 requirement for mobile cellular communications and the subsequent use of GPS in order to fulfill this requirement has necessitated the development of new methods to perform GPS navigation solutions. Unlike standard GPS, weak-signal or AGPS is not able to extract all the information from the GPS signal due to extremely weak signal to noise ratios. As a result, a weak-signal or AGPS satellite observation generally consists of a 1-ms ambiguous code phase and a measured Doppler frequency compared to a standard GPS observation which consists of a full time-of-transmit (TOT) and a measured Doppler frequency. Nonetheless, AGPS is still able to perform a navigation solution through the use of prior information, including a rough estimate of the position of the receiver and a time tag for the time-of-receipt (TOR). The rough estimate of position of the receiver is generally based on the location of the cell-site, although it could be based on the use of previous estimates or calculated using a Doppler based solution. These parameters can then be used to estimate ranges to each satellite which together with the initial TOR estimate can be used to estimate a full TOT for each satellite. However, since the initial TOR typically contains errors, the reconstructed TOTs will all be subject to a common timing error thereby resulting in navigation position errors in the solution process.

The problem of time-recovery for AGPS is discussed in J. Syrjarinne, “Possibilities for GPS Time Recovery with GSM Network Assistance,” presented at ION GPS 2000, Salt-Lake City, Utah, 2000 and M. M. Chanarkar, “Resolving time ambiguity in GPS using over-determined navigation solution.” United States of America: Sirf Technology, Inc, 2003. These references outline general algorithms for solution of the timing error through addition of an additional variable and its solution using least squares techniques. However those algorithms suffer from a poor rate of convergence requiring a large number of iterations in order to reach an acceptable solution. In some cases, up to 500 iterations were required; this being a significant problem when being implemented on a small embedded processor as employed in a typical mobile phone. In some scenarios the algorithm simply failed to converge and hence no solution was obtained. Furthermore, a weighting process employed to avoid poor timing error corrections for near zero range-rates, did not fully solve the problem.

Furthermore, those systems lack any predictive mechanism for determining when their algorithms are unreliable and thus leave the user uncertain whether or not to rely on their resolution of the time-of-transmit and accordingly on their position solution.

### BRIEF DESCRIPTION OF THE INVENTION

The invention is embodied in a GPS device having a processor that runs an algorithm for determining TOT, the time of transmit of a satellite signal. The invention relates to all forms of GNSS including the GPS, Glonass and Galileo systems and others plus augmentation systems such as WAAS, LAAS, EGNOS, MSAS and others. The term GPS will be understood to refer to all of these systems.

Inaccuracies in the receiver clock are the source of errors in the TOT. After adjusting the TOT by the phase shift between a locally generated C/A code and the satellite gold code, a calculation in a single stage is performed in which both the receiver clock error at and the TOT error ΔT are determined. A measurement matrix is used whose row elements are the partial derivatives of the pseudorange with respect to the unknowns, in this case including an addition timing error term. The solution is obtained by applying the pseudoinverse of the measurement matrix to the difference between the predicted and measured pseudorange vector.

At the same time, the Dilution of Precision is calculated based on the measurement matrix. The DOP provides a prediction of the accuracy of the solution. Other embodiments use the accurate time determination when time signals are required.

### SUMMARY OF APPLICABILITY

In a GPS positioning system time errors of tens of milliseconds result in position errors of only a few meters. The dominant sources of error are the path length errors that result from the fact that indoor signals arrive via reflections from near or distant objects (usually buildings). Hence it is not critical to resolve time errors of up to a few tens of milliseconds. However, larger time errors result in large errors in the estimates of the positions of the satellites and this results in large position errors.

In an A-GPS positioning system the position may be determined at the mobile or by a central unit such as the Position Determining Entity (PDE) in a CDMA cellphone system. Either way, the position is determined by resolving the ambiguities in the codephases to turn them into unambiguous pseudoranges and also estimating the Times of Transmission so that the satellite positions can be calculated. In most A-GPS applications the position can be estimated a-priori by some means (eg cellphone tower location) with an ambiguity of only a few kilometers. In a CDMA system the time can be estimated very precisely (nanoseconds). However, there are other situations where the assistance available is much more limited and the algorithms we are disclosing relate to these situations as well as to indoor timing.

In a standard GSM cellphone system the time assistance will have uncertainty of 2 seconds. If we estimate the Time Of Receipt (TOR) based on this then the Times Of Transmission (TOTs) we compute will be up to 2 seconds out. This will cause a big error in the satellite positions used to resolve the codephase ambiguities and to compute the position solution. Thus the disclosed methods come into play here.

There may be other applications where the assistance is supplied by a global or continental server. This will be able to provide ephemeris and time with an uncertainty of a few seconds. However, it may have very scant knowledge of the mobile's position if any. Thus more of our methods are applicable here.

A typical application of the invention is a GPS receiver used to synchronize a wireless communications device. The device incorporates an in-built GPS antenna and is used indoors. Hence the GPS receiver must use GPS signals received from an indoor antenna. The communications device has internet access via which it is able to receive assistance for the GPS receiver. This assistance consists of position, time and ephemeris data for the satellites in view. The ephemeris data is the set of orbital coefficients for each satellite. This data is also transmitted by the satellites. However, the signals received indoors may be too weak for any data to be extracted. In this case the disclosed techniques can be used to resolve the codephase ambiguities and hence to determine time to accuracy below 1 microsecond.

The scheme can also be applied for GPS positioning with limited assistance such as indoors or in a heavily obscured location.

The data in the data store (see below) can be determined from the assistance supplied to the receiver. The ephemeris data occurs in certain subframes of the navigation message modulated in Binary Phase Shift Key (BPSK) onto the signal received from the carrier. The exact bit sequence in the navigation message can be reconstructed by the firmware from the ephemeris data supplied to it. The approximate alignment of this data sequence in time can also be determined since the approximate time has been supplied and the time alignment of the subframes is known a-priori. The firmware is only then required to test candidate data alignments over a range equal to the uncertainty in the time assistance and the uncertainty in the time of flight from the satellites. The time of flight can be estimated based on the calculated satellite position and the position assistance for the receiver.

Now there are several possible scenarios based on the uncertainty in the position assistance as follows:.
1. If the required timing accuracy is x seconds then the receiver need not compute its own position provided the uncertainty in the position known a-priori or provided via assistance is below cx meters where c is the speed of light in meters per second. For example, if 10 us accuracy is required then the position assistance uncertainty must be below approximately 1500 meters with some margin. This is because the greatest possible error in the assumed time of flight due to the position error of cx is equal to x. If the uncertainty is below cx by a suitable margin for other error sources then the receiver requires only a single satellite to achieve time synchronization. Once one signal has been acquired then, if it is too weak for data extraction, its codephase ambiguity can be resolved by the disclosed means and the time synchronization achieved.
2. If the uncertainty of the position known a-priori or provided via assistance is below 75 km then the maximum error in the time of flight due to the position error is 0.25 milliseconds or a quarter of one code epoch. This means that once the codephase ambiguity has been resolved for one satellite signal it can also be resolved for any other satellite signals being tracked. In this case the disclosed ambiguity resolution algorithms need only be applied to a single satellite signal. Then unambiguous measurements can be determined for all other signals being tracked and the position can be estimated in the normal way. Once the position has been determined to the accuracy required as indicated in point 1 above then the time synchronization is achieved.
3. If the uncertainty of the position known a-priori or provided via assistance is below 1500 km then the maximum error in the time of flight due to the position error is 5 ms or a quarter of one data bit period. A data bit period is the ambiguity remaining once bit synchronization has been achieved. Hence the ambiguity resolution algorithm disclosed need only be applied for a single weak signal. Bit synchronization is then required for each of the other weak signals being tracked and then the ambiguity can be resolved for all of the signals. Once that is done the position can be estimated in the usual way. Once the position has been determined to the accuracy required as indicated in point 1 above then the time synchronization is achieved.
4. If the uncertainty of the position known a-priori or supplied via assistance is greater than 1500 km then there are two possible approaches to resolving the ambiguities as follows:

A Doppler-based position solution method can be used to reduce the position uncertainty to below 1500 km. Such methods rely on the relationship between the position of the receiver and the Doppler frequency shift due to the satellite motion. Using this relationship, the position can be estimated using the Doppler measurements alone. Although the resulting position errors can be quite large, they will typically be well below 1500 km. Since the Doppler measurements are unambiguous, they can be used to estimate position prior to the resolution of the codephase ambiguities. Then, if the uncertainty in that position is below 1500 km, the position and time can be determined as indicated in points 1 to 3 above.

The full ambiguity resolution scheme can be applied to all of the weak signals to be employed.

### BRIEF DESCRIPTION OF THE DRAWINGS

FIG. 1 depicts the timing for a satellite signal in the present invention.

FIG. 2 depicts a satellite configuration for an example used to demonstrate the invention.

FIG. 3 depicts a weak signal bit synchronization scheme by performing non-coherent correlations over many rounds.

FIG. 4 depicts apparatus for testing the validity of a candidate time resolution by long coherent correlation across many bit periods.

### DETAILED DESCRIPTION OF PREFERRED EMBODIMENTS

GPS observations used in AGPS Mobile Station Assisted (MS-Assisted) or MS-Based navigation solutions generally consist of a set of C/A code phases measured at a given time-instant as well as Doppler frequency measurements. Since the C/A code has a repetition frequency of 1 kHz, this means that the C/A code phases indicate the TOT modulo 1 ms. For a navigation solution to be performed, it is necessary to reconstruct the full TOT for each satellite. This process generally starts with an estimate of the TOR, the time instant at which the observation was made, which is generally obtained using assistance from the cell phone or real time clock (RTC). Subtracting an estimate for the satellite signal's time-of-flight (TOF) from the TOR then provides an estimate for each satellite TOT. The time of flight is essentially the phase shift in the C/A signal modulo the length of a C/A code epoch of 1 ms. Each TOT can then have it's sub-millisecond portion replaced by the measured code phase and the resulting TOTs can then be corrected by a integer number of millisecond epochs such that the times are consistent with the specified coarse receiver location. Boundary truncation or round-off problems can be avoided by adjusting the initial TOR such that after application of the measured code phases, at least one satellite has a millisecond adjustment that is exactly zero. This procedure produces a set of reconstructed TOTs that is consistent with the true location at which the measurement was made and that can be then used to perform a navigation solution.

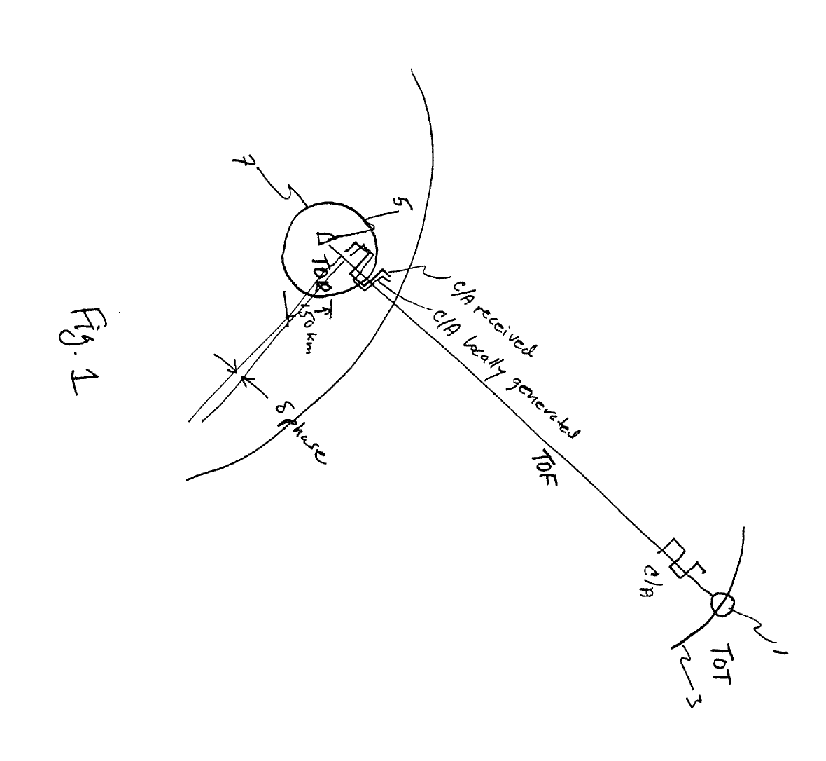

As shown in FIG. 1, a satellite 1 in an orbit 3 transmits a signal to a receiver 5 located on or near the surface of the earth. A portion of the signal, typically the start of an epoch, commences its transmission at a time TOT as measured by an accurate satellite clock, and commences its reception at a time TOR as measured by a less accurate receiver clock. When the signal arrives at the receiver it is detected by its correlation with a locally generated C/A code. The phase difference between the locally generated code and the received code translates into a time difference modulo the length of a code epoch. The epoch difference is constrained by knowledge of the approximate location 7 of the receiver to an accuracy of about 75 km, since the speed of light is approximately 300 km/ms and the epoch length is 1 ms.

A problem with the above procedure is that any error in the initial TOR will result in biased TOTs. Where this causes a problem is that each TOT is used to estimate the position of the corresponding satellite in its orbit 3 which means that if the TOT is incorrect then the satellite position will be incorrect as well. Since each satellite range rate lies in the range of ±1000 m/s, a timing error in the TOT of as little as 0.01 seconds can result in pseudorange predictions that are in error by 10 m, while errors of 1 second can result in 1000 m pseudorange errors. These errors then result in biases in the calculated positions.

The problem can be solved if there is redundancy in the number of satellite observations used to perform the navigation solution. In a standard GPS solution, four observations are used to solve for four different state variables, namely (x, y, z, cΔt), where x, y and z are the WGS84 coordinates of the receiver, c is the speed of light and Δt is the clock error in the TOR. It should be emphasized that this clock error Δt in the TOR is different from the timing error ΔT that is present in the estimated TOTs when AGPS is carried out. In an AGPS solution, the dimension of the state vector is increased by addition of the timing error ΔT and an additional observation used to solve for this additional unknown.

The present invention is best understood by comparison with the following two stage algorithm. In the two stage algorithm, the pseudorange error for each satellite i is modeled as:

$$\begin{matrix}{PR}_{i} = {R}_{i} + c Δ t + {\dot{R}}_{i} Δ T & ( 1 ) \\ \begin{matrix}{R}_{i} = {x}_{i} - x \\ \begin{matrix}{R}_{i} = ‖ {R}_{i} ‖ \\ = \sqrt{{R}_{i} \cdot {R}_{i}} \\ = \sqrt{{( {x}_{i} - x )}^{2} + {( {y}_{i} - y )}^{2} + {( {z}_{i} - z )}^{2}}\end{matrix} \\ \begin{matrix}{\dot{R}}_{i} = \frac{d }{d t} ( \sqrt{{R}_{i} \cdot {R}_{i}} ) \\ = \frac{{R}_{i} \cdot {\dot{R}}_{i}}{{R}_{i}} \\ = \frac{( {X}_{i} - x ) ( {\dot{x}}_{i} - \dot{x} ) + ( {y}_{i} - y ) ( {\dot{y}}_{i} - \dot{y} ) + ( {z}_{i} - z ) ( {\dot{z}}_{i} - \dot{z} )}{{R}_{i}}\end{matrix}\end{matrix} & ( 2 )\end{matrix}$$

where PRᵢ is the pseudorange for satellite i, Rᵢ is the range for satellite i, \dot{R}ᵢ is the range-rate for satellite i, Δt is the TOR clock error and ΔT is the timing error in TOT. Rᵢ is calculated using the satellite position at the current TOT xᵢ or (xᵢ, yᵢ, zᵢ) and the receiver position x or (x, y, z).

Given this model, the two stage algorithm used solves for (x, y, z, cΔt) using a standard GPS solution process after which equation (1) was used to create a set of equations permitting a value for ΔT to be obtained. The calculated ΔT value would then be used to correct all of the TOTs, the satellite positions (xᵢ, yᵢ, zᵢ) were then recalculated and the process repeated. There are a number of ways in which (1) can be used to solve for the value of ΔT. One method is to substitute the calculated Δt value from the position solution thereby providing a set of five or more equations each with a single unknown, namely the ΔT quantity. Using these equations, five or more estimates ΔTᵢ are obtained by re-writing (1) as:

$$Δ {T}_{i} = \frac{{PR}_{i} - {R}_{i} - c Δ t}{{\dot{R}}_{i}} \qquad ( 3 )$$

These values can then be averaged in order to obtain the final ΔT value. The problem with this approach is that the range-rate quantity can lie anywhere in the range of −1000 m/s to 1000 m/s, including zero. When the range rate \dot{R}ᵢ is close to zero, the resulting ΔTᵢ estimate can be poor and this can contaminate the final estimate Δ\hat{T}. In order to fix this problem, an additional weighting process was introduced whereby rather than giving each ΔTᵢ estimate equal weighting, as is the case for an average, the weighting depends on the value of \dot{R}ᵢ. Two different weightings were tested as given in (4) and (5).

$$Δ \hat{T} = {\sum }_{i = 1}^{N} \frac{Δ {T}_{i} \vert {\dot{R}}_{i} \vert}{( \sum \vert {\dot{R}}_{j} \vert )} \qquad ( 4 )$$

$$Δ \hat{T} = {\sum }_{i = 1}^{N} \frac{Δ {T}_{i} {\dot{R}}_{i}^{2}}{( \sum {\dot{R}}_{j}^{2} )} \qquad ( 5 )$$

The effect of these weighted means is to give low weighting to estimates derived from range-rates close to zero and larger weights to values derived from higher range-rates. Estimates derived from values very near to zero were excluded from the solution completely.

An alternate method of performing the solution for ΔT is to recalculate both Δt and ΔT at each position solution step. This can be done by constructing a vector of PRᵢ, Rᵢ and \dot{R}ᵢ as PR, R and \dot{R} respectively and rewriting (1) as

$$PR - R = [ 1 \dot{R} ] [ \begin{matrix}c Δ t \\ Δ T\end{matrix} ] \qquad ( 6 )$$

where 1 denotes a vector of 1's. This can then be used to solve for cΔt and ΔT using a standard pseudo-inverse. This method did not seem to be as susceptible to the problem of zero \dot{R}ᵢ values as the previous technique, probably because of the presence of the cΔt variable constraining the solution in some way.

The iteration process between solving for a new ΔT value and recalculating the solution process using the calculated ΔT value continued until the magnitude of the applied corrections became reasonably small. Both of these techniques generally resulted in reasonable position solutions being obtained for a range of initial timing errors, although the methods were observed to suffer from a number of problems. One problem that was observed early in the process was a poor rate of convergence requiring a large number of iterations in order to reach an acceptable solution. In some cases, up to 500 iterations were required; this being a significant problem when being implemented on an small embedded processor as employed in a typical mobile phone. Furthermore, although the weighting process did improve the performance with near zero range-rates, it appeared as though this solution did not fully solve the problem. Finally, it was observed that occasional scenarios would be encountered in which the algorithm failed to converge and hence no solution was obtained. The combination of all these problems led to the development of the preferred embodiment of the present invention.

The single stage algorithm just described was developed as a minimum change addition to an existing process. This was achieved by simply nesting the new step within the existing process and iterating until convergence took place. Unfortunately good convergence did not always take place and it was conjectured that part of the reason for this was due to the fact that the solution process was being performed in two separated steps rather than a single step.

To overcome these defects, the entire solution process was modified so that all of the unknowns were updated at in a single operation. This required modification of the measurement matrix H so that rather than solving for (x,y,z,cΔt) the process solved for (x, y, z, cΔt ΔT) instead. As is the case for a standard GPS solution, the rows of H are given as the partial derivatives of the PRᵢ with respect to the unknowns, except in this case an additional timing error term ΔT is present. Row i of the H matrix is Hᵢ given by

$${H}_{i} \approx ( \frac{( {x}_{i} - x )}{{R}_{i}} \frac{( {y}_{i} - y )}{{R}_{i}} \frac{( {z}_{i} - z )}{{R}_{i}} 1 - {\dot{R}}_{i} ) \qquad ( 7 )$$

where the

$$\frac{\partial {\dot{R}}_{i}}{\partial x} , \frac{\partial {\dot{R}}_{i}}{\partial y} and \frac{\partial {\dot{R}}_{i}}{\partial z}$$

contributions have been ignored since their magnitudes are small.

The signs of the partial derivatives have also been reversed to make the H matrix similar to the matrix typically used to calculate Dilution of Precision (DOP), thereby permitting DOP to be calculated using the same matrix. (DOP is a term that describes the geometric strength of a satellite configuration. When visible satellites are close together in the sky, the geometry is said to be weak and the DOP value is high; when far apart, the geometry is strong and the DOP value is low. Factors that affect the DOP are, besides the satellite orbits, the presence of obstructions which make it impossible to use satellites in certain sectors of the local sky.) This reversal of signs requires that the solution process adjust the signs of the input quantities to compensate accordingly. It also makes sense to express the range-rate terms with units of km/s rather than m/s thereby ensuring that the magnitude of all matrix elements are similar. This results in the solved TOR error having units of milliseconds rather than seconds.

Defining y as the measured pseudorange vector, and y as the predicted pseudorange vector given a particular estimate of the state vector x, an update to state Δx can be given by

Δx=(H^{T}H)⁻¹H^{T}Δy

y=[PR₁ . . . PRₙ]^{T}

ŷ=[R₁−cΔt . . . Rₙ−cΔt]^{T}

Δy=(ŷ−y) (8)

where n is the number of satellites and the sign of Δy has been adjusted to match the DOP friendly H matrix. Following the calculation of each state correction Δx, the correction is applied and the predicted range vector ŷ updated before repeating the process. The process is terminated when the magnitude of the calculated correction Δx becomes sufficiently small. This typically takes less than 10 iterations and is significantly faster than the two-stage algorithm.

The algorithm just described may be improved in a number of ways. Firstly, it is often the case that two-dimensional fixes need to be performed during periods of reduced satellite availability, so support for this requirement may be included. One way in which this can be done is to add a ‘fake’ satellite in the center of the earth and then specify a required pseudorange for that satellite. The corresponding row of the H matrix is then constructed as the partial derivatives of the WGS84 reference ellipsoid evaluated at the estimated position, where the ellipsoid is described as

$$\begin{matrix}{R}_{0} = R ( x , y , z ) \\ = \sqrt{{x}^{2} + {y}^{2} + {( \frac{a}{b} z )}^{2}}\end{matrix} \\ {H}_{n + 1} \approx ( \frac{x}{R ( x , y , z )} \frac{y}{R ( x , y , z )} \frac{{a}^{2} z}{{b}^{2} R ( x , y , z )} 0 \; 0 ) \qquad ( 9 )$$

(a/b)² defines the WGS84 ellipsoid and R₀ defines the altitude constraint. One problem with 2D solutions is that when the solution is over-determined, there is no hard constraint that forces the solution to the altitude specified by the user. To deal with this and also improve the solution process in general, a weighted least squares solution process is performed. Each observation is given a corresponding weighting related to the estimated RMS error that is reported with each observation. This also solves the 2D problem since the 2D observable can be given a significantly larger weighting than the other observables thereby establishing an effective altitude constraint. When weighting is added to the solution process, equation (8) is changed to

Δx=(H^{T}R⁻¹H)⁻¹H^{T}R⁻¹Δy (10)

where R⁻¹ is the weighting matrix. R is generally a diagonal matrix in which the noise-variance of each observation is the corresponding diagonal element in R, so observations with a low noise variance end up as large values in the inverted matrix R⁻¹.

Another feature of a preferred embodiment is to permit the use of differenced pseudoranges for solution of the (x, y, z, ΔT). This is implemented by modifying the H and R matrices once all the measured satellite observations have been inserted (but before adding the fake 2D observation). The modification involves selecting a reference satellite (usually the highest one) and then subtracting the reference satellite row from each of the other rows. Performing a differenced observation in this way eliminates the clock error cΔt as a solution state. It is also possible to disable the solution of the timing error for situations in which exact TOTs or accurate time-aiding is available omitting the final range-rate column of H thereby resorting to the standard formulation. This is also useful for permitting calculation of the receiver velocity solution since the H matrix required for a velocity solution is the same as a standard position solution. Only the input and output vectors change for this situation, which in this case are pseudorange-rates and receiver velocity respectively.

Although the single stage algorithm resulted in significantly better performance than its two-stage predecessor, it nonetheless was observed to occasionally suffer large position errors. These position errors occurred despite the use of observations obtained from observations with high signal to noise ratios and were more likely when the minimum number of observations were being used (i.e. five). To investigate the reasons for this, the measurements from such a failure were captured and the execution of the algorithm examined within a MATLAB environment. The cause of the failure was subsequently identified as being caused by the H matrix being severely ill-conditioned, i.e. small changes in matrix elements having drastic effects on the results of calculations. The unusual aspect of this situation was that although H was ill-conditioned, the DOP resulting from the matrix, although large in magnitude was not sufficiently large to explain the error. A complete end-to-end Matlab simulation including the generation of simulated measurements and solution using those measurements subsequently confirmed these captured measurement results.

The case study prompting this solution occurred with the following dataset given in Table 1, although the effect is readily observable in other datasets. Table 2 shows the resulting satellite positions and range-rates for the constellation at this time, while FIG. 1 shows provides a graphical representation of the satellite visibility.

TABLE 1
CASE STUDY TIME AND LOCATION

| Latitude | S 35° 19′ 50.84″ |
|---|---|
| Longitude | E 149° 11′ 13.57″ |
| Altitude (m) | 600 |
| X | −4474390 |
| Y | 2668637 |
| Z | −3668214 |
| Week/Time-of-Week | 1284/46663 |
| Date/Time (UTC) | 15 August 2004 12:57:43 |
| Almanac Week/Toa | 260/319488 |

TABLE 2
CASE STUDY SATELLITE POSITIONS/RANGE-RATES

| SV | X (m) | Y (m) | Z (m) | RR (m/s) |
|---|---|---|---|---|
| 1 | −4621252 | 12278380 | −16123674 | −137.59 |
| 11 | −8229820 | 20353051 | 546065 | 369.3 |
| 14 | −10757063 | −20459050 | −8825156 | 501 |
| 16 | −21533507 | −3586705 | 9122087 | −560 |
| 20 | −2660574 | 11259716 | −17866682 | −402. |
| 23 | 924125 | 18878119 | −11492008 | −322.8 |
| 25 | −13265464 | −1908760 | −15717813 | 317.9 |

The problem occurs if the subset of the above constellation given by satellites 1, 11, 16, 20 and 23 is used to perform the solution, with satellites 14 and 25 omitted from the solution process. The H matrix (in WGS84 XYZ coordinates) corresponding to the use of these observables is given by

$$H = ( \begin{matrix}- 0.222 & 0.591 & - 0.776 & 1 & - 0.138 \\ - 0.375 & 0.927 & 0.025 & 1 & 0.369 \\ - 0.910 & - 0.152 & 0.386 & 1 & - 0.560 \\ - 0.125 & 0.529 & - 0.839 & 1 & - 0.402 \\ 0.042 & 0.853 & - 0.520 & 1 & - 0.323\end{matrix} )$$

If the standard GPS DOP is calculated by defining H as H with the last column deleted and calculating (\tilde{H}^{T}\tilde{H})⁻¹ the result is

$${( {\tilde{H}}^{T} \tilde{H} )}^{- 1} = ( \begin{matrix}25.7 & - 11.5 & 10.4 & 18.1 \\ - 11.5 & 7 & - 4 & - 8.8 \\ 10.4 & - 4 & 5.4 & 7.4 \\ 18.1 & - 8.8 & 7.4 & 13.3\end{matrix} )$$

The GDOP (Geometric Dilution of Precision) can then be calculated as the square root of the trace of this matrix, giving a GDOP value of 7.17, which although higher than normal is not excessive. However, if the DOP is calculated using the H matrix as actually used in the solution process, a result with significantly larger magnitude is obtained.

$${( {H}^{T} H )}^{- 1} = {10}^{10} \times ( \begin{matrix}5.36 & - 4.63 & 1.21 & 5.25 & 2.75 \\ - 4.63 & 4 & - 1.05 & - 4.53 & 2.38 \\ 1.21 & - 1.05 & 0.277 & 1.19 & 0.62 \\ 5.25 & - 4.53 & 1.19 & 5.14 & 2.70 \\ 2.75 & 2.38 & 0.62 & 2.70 & 1.41\end{matrix} )$$

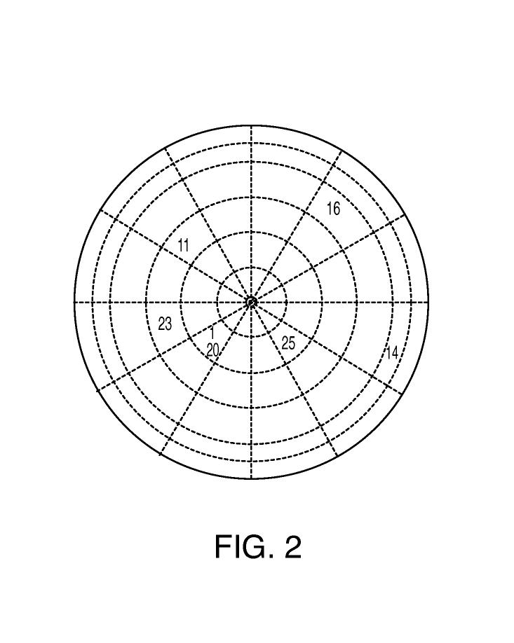

This gives a GDOP of 492536, which is much larger than the standard method of 7.23, where the new augmented DOP calculation is the natural extension of the standard method. Hence the use of these observables clearly has a geometry making the solution with this set completely infeasible. These results were obtained from the simulation using almanac to define the satellite locations and velocities, although when the ephemeris from the captured log were used the resulting GDOP had a lower value of approximately 400. This difference is due to slight differences in the satellite positions between using the YUMA almanac and captured ephemeris. An examination of FIG. 2 provides an intuitive reason for this failure, namely that satellite 1 and 20 are almost co-located which means that the geometry is effectively a 4 satellite solution even though 5 satellites are being used.

It should be noted that when reasonably good geometries are present, the numerical values for the extended DOP are generally similar to the values obtained using the conventional approach. However, in cases where the extended DOP is high, it means that the timing error and navigation solution cannot be reliably calculated.

### Application to Weak Signal Timing

In addition to the application of the technique to E911 navigation solutions, the technology is also applicable to the newly developing field of GPS weak signal timing receivers. As the name suggests, this involves the use of GPS for time-transfer, except that the receiver only has access to weak signals and obtains ephemeris, coarse location and coarse time from other sources such as the Internet or wireless links. The main reason for requiring such receivers is either convenience, with many environments not being GPS antenna friendly or the requirement to provide timing in areas of heavy vegetation where GPS signals are obscured.

A number of different options are available to achieve this goal. The first option is to formulate the solution in terms of an extended Kalman filter (P. Axelrad and R. G. Brown, “GPS Navigation Algorithms,” in Global Positioning Systems: Theory and Applications Volume 1, B. W. Parkinson, J. J. Spilker, P. Axelrad, and P. Enge, Eds.: American Institute of Astronautics and Aeronautics, Inc, 1996.), rather than the single shot solution algorithm just described. The procedure for doing this is straightforward and requires the inclusion of the TOR timing error ΔT as an additional element in the Kalman filter state vector. The state covariance must also increase to account for the additional dimension and the new H matrix used instead of the normal H matrix. The Kalman filter can then be operated over a number of GPS measurements until the state-covariance associated with ΔT has fallen significantly below one millisecond. Provided the Kalman filter state covariance represents a realistic estimate of the error it is then possible to correct the receiver TOR using the calculated estimate after which this TOR can be locked-in and a switch to a conventional solution process performed.

In addition to the use of the above process, it is also possible to take advantage of the fact that in practice a spread of satellite signal levels will generally be present. Even if the signal to noise ratio is too low to reliably extract data; those same signal levels may still permit bit-synchronization to be achieved (i.e. determine the locations of the bit boundaries). Provided that this can be done, then the ambiguity associated with each GPS observation improves from 1 ms to 20 ms. This is of benefit for a weak signal timing application where the two pieces of information may be combined to determine the TOR with no ambiguity using the following procedure.

Using the standard code phase ambiguity resolution, generate reconstructed measurements for the TOR algorithm. At this point, the bit-synchronization information for the satellite is not used.

Run the algorithm and obtain an estimate for the TOR error.

Apply the TOR error to all of the satellite observations and the incorrect TOR. If the TOR had no error then the C/A epoch calculated from the observation with bit-synchronization should match the measured epoch. If it does not match then apply an additional correction to ΔT to ensure that a match occurs.

### Additional Embodiments

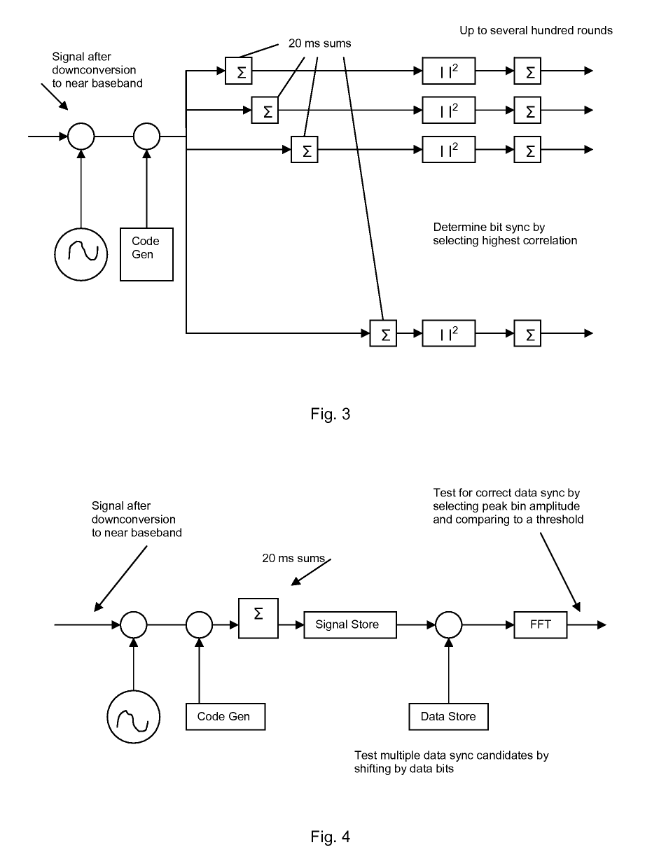

As an alternative embodiment bit sync could be obtained by performing non-coherent correlations over many rounds (typically 50 to several hundred) of 20 ms coherent correlations using 20 offsets at 1 ms spacing and choosing the alignment that yields the highest correlation. In that case, the 1 ms ambiguity of the codephase is replaced by a 20 ms ambiguity for the bits. FIG. 3 depicts such a synchronization scheme. The complex signal from the GPS front-end is downconverted as closely as possible to DC. This needs to be sufficiently close such that the sample phase does not rotate appreciably during one 20 ms coherent integration period. The absolute phase of the signal can be arbitrary. Both the in-phase (I) and quadrature (Q) components of the complex signal samples are multiplied by the code to ‘despread’ the signal so that it occupies a narrow signal bandwidth. (Note that FIG. 3 does not show the I and Q components separately.) Then the signal samples (both I and Q) are summed over 20 ms intervals in 20 summers spaced in time at 1 ms intervals. The alignment of these intervals to the bit intervals determines the magnitude of the signal components of the resulting sums with the one that is properly aligned giving the largest result. However, where the signal to noise ratio is very low, the noise component dominates in a single coherent integration period. For this reason the squared magnitude of the complex coherent sums are further summed over many rounds of coherent summation resulting in non-coherent sums for which the signal component dominates over the noise component. The magnitudes of the sums can now be used to determine which coherent interval is aligned with the bit intervals in the incoming signal. It is necessary to not only determine the bit alignment but also to decide whether a reliable determination has been made. One way to do this is by comparing the difference between the largest sum and the next largest sum to a threshold. The threshold can be determined a-priori based on estimated signal carrier to noise ratio or adaptively. This process can be repeated in order to improve its integrity by dramatically reducing the probability of error.

In addition the invention can be used to determine time to better than 10 ms, by utilizing the TOR-resolving position-Time Kalman filter. By combining this better time resolution with the 20 ms bit ambiguity one can completely resolve the ambiguity leading to precise time resolution using the codephase measurements with no ambiguity.

The validity of the time resolution can be tested by performing long coherent correlations across many bit periods taking account of the bit sequence known in advance. This will yield a very high correlation if the bit ambiguity has been properly resolved. If not, this will yield a very low correlation and one could re-resolve the ambiguity. This step may be considered either a test for correct resolution of the 20 ms ambiguity or a method for resolving the 20 ms ambiguity depending on whether a single test is performed or multiple tests. The basic idea is to correlate the signal with the known navigation data bits over several hundred bits. Since bit synchronization has already been achieved, the signal is pre-integrated over 20 ms bit-periods. Several hundred of these bit-aligned partial integrals are stored in a Signal Store. These are then multiplied by the test bits and summed to provide a correlation value to be tested by comparison with a threshold. Multiple tests can be performed by repeating with bit-shifted sequences of the partial sums or the data bits.

The process is depicted in FIG. 4. Note that the signal is being tracked in code phase and frequency and in carrier frequency. However, some residual carrier frequency will typically be present. Therefore, rather than simply summing the partial sums after multiplication by the data bits, an FFT is used. Integration over several seconds will suffer from the phase rotation of the signal leading to significantly reduced correlation and may result in failure to resolve the ambiguity unless the residual carrier phase rotation is allowed for. To perform the test of each ambiguity resolution candidate we simply test for correct synchronization of the signal with the data sequence which is known a-priori. This is done by picking the peak of the FFT and testing this against a threshold. The threshold may be determined from the statistics of the correlations across all of the candidates. For example a threshold may be set as several standard deviations above the mean across all candidates. In order to ensure that the successful candidate is clearly distinguished from all other candidates a secondary threshold can be set in a similar way and no other candidate may be permitted to be above the secondary threshold for the test to be successful. If no candidate is successful a new set of samples is read into the signal store and the process is repeated.

Where this latter process is used with an increased search range, so that it covers the complete range of the initial time uncertainty, it is not necessary to include the step of using the TOR-resolving position-Time Kalman filter to determine time to better than 10 ms.

Once the ambiguities are resolved in a particular embodiment one may track time continuously by monitoring codephases, counting code epochs and taking account of measured Doppler offsets. The accurate time could be further utilized by outputting synchronization pulses at any desired repetition rate with sub-microsecond precision and stamping these with time via a communications port of some sort. Similarly one could discipline the receiver's reference oscillator by estimating the frequency bias of the oscillator using the Doppler measurements and the estimated time and position and steering the local oscillator to the correct frequency.

Although the invention has been discussed in terms of specific embodiments, persons of skill in this art will see its full utility. Accordingly the invention is intended to cover what is described in the following claims.

What is claimed is:

1. A method for application in a GPS device for determining the time of transmit of a GPS signal (TOT) comprising the step of obtaining bit sync by performing non-coherent correlations over rounds of coherent correlations using multiple offsets at a predetermined spacing and selecting the alignment that yields the highest correlation.

2. The method of claim 1 for application to a weak signal, wherein the bit alignment of the weak signal is determined by the steps of
(a) downconverting a complex signal from a GPS front-end to near DC.,
(b) multiplying the in-phase (I) and quadrature (Q) components of the complex signal to ‘despread’ the signal into a narrow signal bandwidth.
(c) summing both I and Q over time intervals in summers spaced in time at predetermined intervals,
(d) selecting the largest of the resulting sums,
(e) summing the squared magnitude or any alternative moduli of the complex coherent sums over rounds of coherent summation,
wherein the signal component dominates over the noise component.

3. The method of claim 2 wherein it is determined whether a reliable determination of bit alignment TOT has been made by the steps of comparing the difference between the largest sum and the next largest sum to a threshold T

4. The method of claim 1 further comprising employing a TOR-resolving position-Time Kalman filter, wherein the time of transmit is determined to better than 10 ms.

5. The method of claim 4, wherein the codephase measurements completely resolve any time of transmit ambiguity.

6. A method for application in a GPS device for determining, the time of transmit of a GPS signal (TOT) comprising performing long coherent correlations across bit periods.

7. The method of claim 6, further comprising checking for resolution of bit ambiguity and if not resolved repeating the process.

8. The method of claim 7 further comprising
(a) correlating a signal with known navigation data bits,
(b) storing bit-aligned partial integrals in a Signal Store,
(c) multiplying the results of (b) by test bits and
(d) summing to provide a correlation value to be tested by comparison with a threshold.

9. The method of claim 8, wherein multiple tests are performed by repeating with bit-shifted sequences of the partial sums or the data bits.

10. The method of claim 7 further comprising
(a) correlating a signal with known navigation data bits,
(b) storing bit-aligned partial integrals in a Signal Store,
(c) multiplying the results of (b) by test bits and
(d) employing a FFT to provide a correlation value to be tested by comparison with a threshold.

11. The method of claim 10, wherein the peak of the FFT is tested against a threshold.

12. The method of claim 11, wherein the threshold is determined from the statistics of the correlations across all of the candidates.

13. The method of claim 11, wherein a threshold is set several standard deviations above the mean across all candidates.

14. The method of claim 13, wherein a secondary threshold is set and no other candidate may be permitted to be above the secondary threshold for the test to be successful.

15. A method for application in a GPS device for tracking time continuously by monitoring code phases, counting code epochs and including measured Doppler offsets.

16. The method of claim 15 further comprising outputting synchronization pulses at any desired repetition rate with sub-microsecond precision and stamping these with time via a communications port.

17. The method of claim 15 further comprising disciplining a GPS receiver's reference oscillator by estimating the frequency bias of the oscillator using the Doppler measurements and the estimated time and position and steering the local oscillator to the correct frequency.
